(19) United States
(12) Patent Application Publication
(10) Pub. No.: US 2012/0281581 A1
(43) Pub. Date: Nov. 8, 2012

(54) METHOD AND DEVICE FOR SELECTING ACCESS POINT NAME

(75) Inventor: Xueqin Liu, Shenzhen City (CN)

(73) Assignee: ZTE Corporation, Shenzhen City (CN)

(21) Appl. No.: 13/520,617

(22) PCT Filed: Apr. 20, 2011
(86) PCT No.: PCT/CN11/73068

§ 371 Date: Jul. 5, 2012

(30) Foreign Application Priority Data
Aug. 17, 2010 (CN) 201010259054.1

(51) Int. Cl. H04W 48/20; H04W 24/00

(52) U.S. Cl. 370/252; 370/328

(57) ABSTRACT

The present invention discloses a method for selecting an access point name (APN), including: a user triggering an application required to use a data service link; when the user does not start user self-configuration of multi-APN and the application does not need a dedicated APN, a terminal selecting an APN for the application from the information of a corresponding relation between the applications and the APN in a multi-APN selection database according to basic information of the application. The present invention also discloses a corresponding apparatus. The present invention selects different access points for the application for connecting, to realize managing the selection of multiple APNs in a multimode terminal by using the data service.

### TECHNICAL FIELD

The present invention relates to the field of wireless communication technology, and in particular, to a method and an apparatus for selecting an access point.

### BACKGROUND OF THE RELATED ART

In the electronic market of which the competition is fierce day by day, in order to improve the user experience, the network application is integrated in a multimode terminal to meet the network demand of the user similarly on the PC machine. Facts prove that this kind of electronic devices integrated with a large number of network applications have a favorable reception unanimously by the users, and have already been considered as the selection of the advanced electron consumption and the high and top grade configuration.

What deserves to be mentioned is that, in the open source robot operating system (Android OS) supported by the Open Handset Alliance (OHA), there is support for the Internet application itself. Android is an open source mobile phone operating system based on the Linux platform and developed by Google. Android includes the operating system, the user interface and the application program, and the Android platform integrates a large number of applications which require a large number of data services to support, such as, Email, electronic market and Youtube (an online video application), etc. The current Android mostly integrates the currently popular Internet applications, such as, micro blog and Facebook (a social contact application website) terminal application, etc.

However, the Android platform supports the access point (Access Point Name, APN) limitedly, and only supports single APN. It does not support the CMNET when using the CMWAP, and the CMWAP and the CMNET are two access ways of the General Packet Radio Service (GPRS). In real application, the Multimedia Messaging Service (MMS) and the WAP website mostly use the CMWAP to link the data service, while more applications for visiting the Internet rapidly need to use the CMNET. And the support of single APN reduces the user experience greatly. If the application needing different APN to access the data service is used, then it needs to switch over the APN configuration manually. In the multimode terminal, the multi-network system and the multi-APN bring the inconvenience especially to the use.

### Content of the Invention

The technical problem that the present invention will solve is to provide a method and an apparatus for selecting an access point, to realize the self-adaption selection of the APN in the mobile terminal.

In order to solve the above-mentioned technical problem, the method for selecting an access point of the present invention comprises:

a user triggering an application required to use a data service link; and

when the user does not start user self-configuration of multi-APN and the application does not need a dedicated APN, a terminal selecting an APN for the application from information of a corresponding relation between the applications and the APN in a multi-APN selection database according to basic information of the application.

Preferably, the method further comprises:

after the terminal starts up, a wireless module of that terminal performing detection on wireless signal intensity; and

if multiple APNs have been selected from the information of the corresponding relation between the application and the APN, then the terminal screening out an APN with an optimal signal from the multiple APNs that have been selected according to detection data of the wireless signal intensity reported by the wireless module, starting the wireless module corresponding to the APN with the optimal signal, and establishing the data service link for the application.

Preferably, the method further comprises:

before selecting the APN for the application, the terminal further judging whether the application has a particular requirement for the data service link, and if yes, then recording that particular requirement, and selecting the APN for the application from the information of the corresponding relation between the application and the APN in the multi-APN selection database according to basic information and the particular requirement of the application.

Preferably, the method further comprises:

the information of the corresponding relation between the application and the APN in the multi-APN selection database containing: information of a corresponding relation between a self-adaptation application and the APN; and

after establishing the data service link for the application, when the application uses the data service link, the terminal further recording the flow of the data service link, and adjusting the corresponding relation between the application and the APN in the information of the corresponding relation between the self-adaptation application and the APN according to the recorded flow of the data service link.

Preferably, the flow of the data service link comprises: the data service flow used by the application, the data service flow used by the APN and the data service flow used by the wireless module; and

the step of the terminal adjusting the corresponding relation between the application and the APN comprises: sequencing total data service flow has been used by each application, APN and wireless module; adjusting the corresponding relation between the application and the APN according to the sequencing, making the application whose data service flow that has been used is greater than a flow usage threshold correspond to the APN corresponding to the wireless module whose surplus data service flow is greater than a flow surplus threshold; making the application whose data service flow that has been used is smaller than the flow usage threshold correspond to the APN corresponding to the wireless module whose surplus data service flow is smaller than the flow surplus threshold; making the APN corresponding to the wireless module whose surplus data service flow is zero have the lowest priority.

Preferably, the method further comprises:

the information of the corresponding relation between the application and the APN in the multi-APN selection database further containing: the information of the corresponding relation between the user-defined application and the APN, and the terminal displaying editing the information of the corresponding relation between the user-defined application and the APN to the user when the user starts user self-configuration of the multi-APN; and

the terminal searching the APN corresponding to the triggered application from the information of the corresponding relation between the user-defined application and the APN, and starting the data service link of the wireless module corresponding to that APN.

Preferably, the method further comprises:

if one application is corresponding to multiple APNs in the information of the corresponding relation between the user-defined application and the APN, then the terminal displaying editing a preferential list of the data service link to the user, and the list recording ranks of the multiple APNs corresponding to the application; and

when searching the APN corresponding to the triggered application, if the triggered application is corresponding to multiple APNs, then the terminal selecting the APN according to the ranks, and starting the data service link of the wireless module corresponding to the APN has been selected.

Preferably, the method further comprises:

the information of the corresponding relation between the application and the APN in the multi-APN selection database containing information of corresponding relation between the built-in application and the APN, information of corresponding relation between the user-defined application and the APN, priority of the user-defined APN, information of corresponding relation between the self-adaptation application and the APN, and wireless signal intensity information of the APN, whose priorities are from high to low; and

the terminal selecting the APN for the application from the information of the corresponding relation between the application and the APN according to the above-mentioned priority.

The present invention further provides an apparatus for selecting an access point, comprising: an application module and a main control module, wherein:

the application module is configured to send a data service link request to the main control module after triggered by a user; and

the main control module is configured to select an APN for the application module from information of a corresponding relation between the applications and the APN in a multi-APN selection database according to basic information of the application module after receiving the data service link request and when the user does not start user self-configuration of multi-APN and the application module does not need a dedicated APN.

Preferably, the apparatus further comprises a wireless module, wherein,

the wireless module is configured to perform detection on wireless signal intensity and send detection data to the main control module; and

the main control module is further configured to screen out an APN with the optimal signal from the multiple APNs that have been selected according to the detection data of the wireless signal intensity reported by the wireless module if multiple APNs are selected from the information of the corresponding relation between the application and the APN, and to start the wireless module corresponding to the APN with the optimal signal, and to establish the data service link for the application.

Preferably, the information of the corresponding relation between the application and the APN in the multi-APN selection database contains: information of a corresponding relation between a self-adaptation application and the APN; and

the main control module is further configured to record flow of the data service link after the data service link is established for the application and when the application uses the data service link, and to adjust the corresponding relation between the application and the APN in the information of the corresponding relation between the self-adaptation application and the APN according to the flow of the data service link has been recorded.

Preferably, the flow of the data service link comprises: the data service flow used by the application, the data service flow used by the APN and the data service flow used by the wireless module; and

the main control module is configured to adjust the corresponding relation between the application and the APN according to the following way: sequencing total data service flow that has been used by each application, APN and wireless module; adjusting the corresponding relation of the application and the APN according to the sequencing, making the application whose data service flow that has been used is greater than a flow usage threshold correspond to the APN corresponding to the wireless module whose surplus data service flow is greater than a flow surplus threshold; making the application whose data service flow that has been used is smaller than the flow usage threshold correspond to the APN corresponding to the wireless module whose surplus data service flow is smaller than the flow surplus threshold; making the APN corresponding to the wireless module whose surplus data service flow is zero have the lowest priority.

Preferably, the information of the corresponding relation between the application and the APN in the multi-APN selection database contains information of corresponding relation between a built-in application and the APN, information of corresponding relation between the user-defined application and the APN, priority of the user-defined APN, information of corresponding relation between the self-adaptation application and the APN, and wireless signal intensity information of the APN, whose priorities are from high to low; and

the main control module is further configured to select the APN for the application from the information of the corresponding relation between the application and the APN according to the above-mentioned priority.

To sum up, the present invention selects different access points for the application for connecting, to realize managing the selection of multiple APNs in the multimode terminal by using the data service, and to reach and meet the objectives, such as optimally using by a user in the data service application in the Android mobile phone, improving the performance of the data service, reasonably distributing the data service use flow and reducing the data service expenses of the user, thus further improving the user experience, which can meet the customized requirement of the operator, and also can increase the data service performance of the dual-mode terminal and distribute the data service use flow of the dual-mode terminal reasonably.

### BRIEF DESCRIPTION OF DRAWINGS

FIG. 1 is a flow chart of a whole flow of a method for selecting an access point of the present embodiment;

FIG. 2 is a flow chart of realizing self-adaption of multi-APN in a selection method of the present embodiment;

FIG. 3 is a flow chart of realizing selecting user-configuration of multi-APN of the present embodiment;

FIG. 4 is a flow chart of an application example of a method for selecting an access point of the present embodiment;

FIG. 5 is a architecture diagram of an apparatus for selecting an access point of the present embodiment.

### PREFERRED EMBODIMENTS OF THE PRESENT INVENTION

In order to meet the user requirement, and to meet the support of different applications and different networks to multiple APNs at the same time, especially in the multimode terminal, the support to the multi-APN is more urgent, and to further improve the user experience, the present embodiment provides a method for selecting the multi-APN, which can meet the requirement customized by the operator, and improve the data service performance of the multimode terminal, assign the data service use flow of the multimode terminal reasonably, and help to reduce the user data service expenses.

The method for selecting the multi-APN in the multimode terminal provided by the present embodiment mainly includes:

1, the whole realization procedure of the method for selecting the multi-APN in the multimode terminal;

2, the self-adapting realization procedure of the multi-APN;

3, the realization procedure of the user setting the selection policy of the multi-APN;

4, the realization design of the multimode multi-APN selection database;

5, the design of the APN screening policy in the multimode multi-APN selection database.

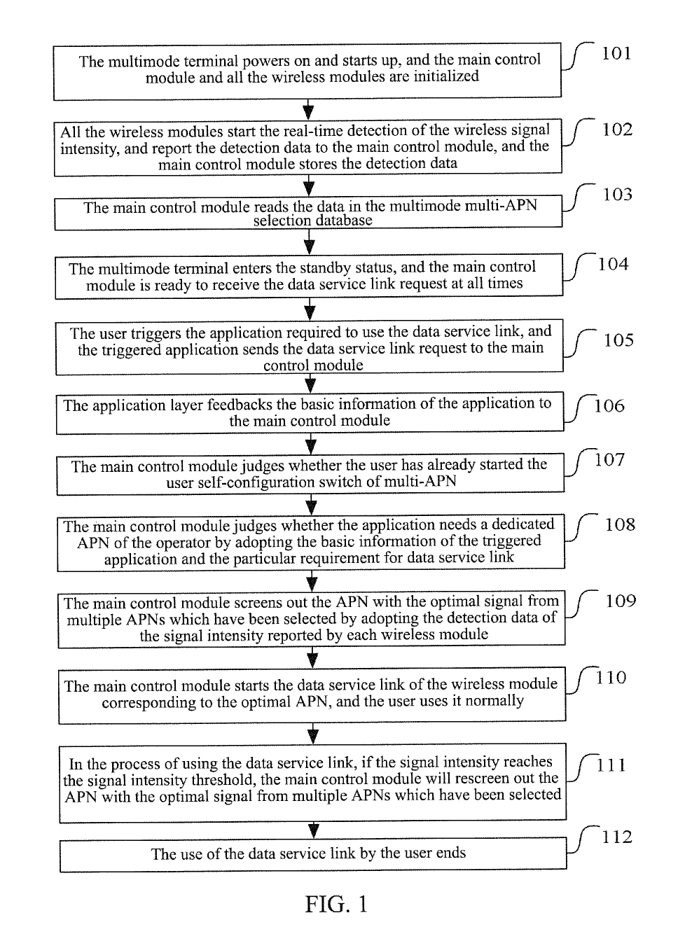

The whole realization procedure of the method for selecting the APN is shown in FIG. 1, including:

in step 101: the multimode terminal powers on and starts up, and the main control module and all the wireless modules are initialized;

in step 102: all the wireless modules start the real-time detection of the wireless signal intensity, and report the detection data to the main control module, and the main control module stores the detection data;

in step 103: the main control module reads the data in the multimode multi-APN selection database;

in step 104: the multimode terminal enters the standby status, and the main control module is ready to receive the data service link request at all times;

in step 105: the user triggers the application required to use the data service link, the triggered application sends the data service link request to the main control module, and the main control module judges whether the application has a particular requirement for the data service link according to that request, and if yes, it records the particular requirement, and requests to the application layer of the terminal to obtain the basic information of the application at the same time, such as, the key word of the application;

the data service link request carrys the specific content and particular requirement, and part of the applications have particular requirements in the data service link, such as, required to use the particular APN, etc.

in step 106: the application layer feedbacks the basic information of the application to the main control module, such as the key word;

in step 107: the main control module judges whether the user has already started the user self-configuration switch of the multi-APN, if already started, then it performs the realization procedure of the user setting selection policy of the multi-APN (step 301˜309); otherwise, it performs the self-adaptation realization procedure of the built-in multi-APN, and performs step 108 at the same time;

in step 108: the main control module judges whether the application needs a dedicated APN of the operator by adopting the basic information of the triggered application (key word) and the particular requirement for data service link, screens in the multimode multi-APN selection database or the database corresponding to the APN customized by the operation, and selects multiple APNs meeting the characteristic of the data service link;

in the corresponding relation table of the application and the APN in the multimode multi-APN selection database, the basic information and particular requirement of the application are recorded.

The main control module judges whether the application needs the dedicated APN of the operator, if it needs, then it screens from the database corresponding to the APN customized by the operator; if it does not need, then it screens from the multimode multi-APN selection database.

In step 109: the main control module screens the APN with the optimal signal from multiple APNs that have been selected by adopting the detection data of the signal intensity reported by each wireless module;

in step 110: the main control module starts the data service link of the wireless module corresponding to the optimal APN, and the user uses normally;

in step 111: in the process of using the data service link, if the signal intensity reaches the signal intensity threshold, the main control module will rescreen the APN with the optimal signal from multiple APNs have been selected (step 109);

the signal intensity threshold can be set according to the empiric value.

In step 112: the use of the data service link by the user ends.

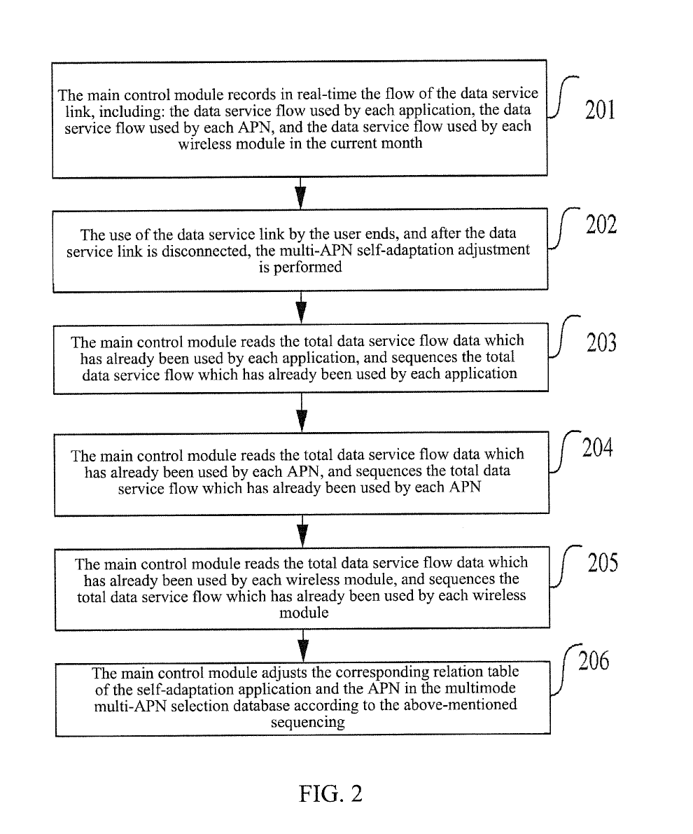

FIG. 2 shows the self-adaption realizing procedure of multi-APN of the present embodiment, including:

in step 201: the main control module records in real-time the flow of the data service link, including: the data service flow used by each application, the data service flow used by each APN, and the data service flow used by each wireless module in that month;

in step 202: the use of the data service link by the user ends, and after the data service link is disconnected, the multi-APN self-adaptation adjustment is performed;

in step 203: the main control module reads the total data service flow data already used by each application, and sequences the total data service flow already used by each application;

in step 204: the main control module reads the total data service flow data already used by each APN, and sequences the total data service flow already used by each APN;

in step 205: the main control module reads the total data service flow data already used by each wireless module, and sequences the total data service flow already used by each wireless module;

in step 206: the main control module adjusts the corresponding relation table of the self-adaptation application and the APN in the multimode multi-APN selection database according to the above-mentioned sequencing, including: adjusting the application whose data service flow that has been used is greater than the flow usage threshold to correspond to the APN corresponding to the wireless module whose surplus data service flow is greater than the flow surplus data threshold; the application whose data service flow that has been used is smaller than the flow usage threshold corresponding to the APN corresponding to the wireless module whose surplus data service flow is smaller than the flow surplus threshold; the APN corresponding to the wireless module whose surplus data service flow is zero having the lowest priority, and the specific sequencing will be calculated according to the charge standard.

The above-mentioned flow usage threshold and the flow surplus threshold value can be set as multiple, and the corresponding relation of the application and the APN is adjusted in grades.

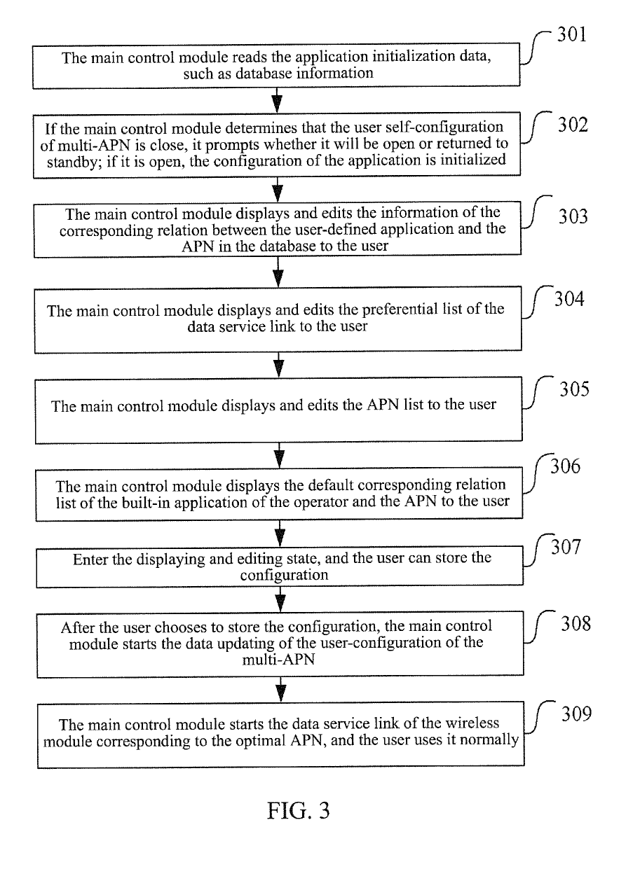

FIG. 3 shows the realization procedure of the user setting multi-APN selection policy, including:

in step 301: the main control module reads the application initialization data, such as, data base information;

in step 302: if the main control module determines that the current state of the user self-configuration of the multi-APN is close, then it suggests whether it will be open or returned to standby; if the current state is open, then it initializes the configuration of the current application according to the application initialization data;

supposing after the multimode terminal powers on and starts up, the user already starts the user-defined configuration application of the multi-APN.

In step 303: the main control module displays editing the information of the corresponding relation between the user-defined application and the APN in the database to the user;

in step 304: if in the information of the corresponding relation between the user-defined application and the APN, the application is corresponding to multiple APNs, then the main control module displays editing the preferential list of the data service link to the user, and that list displays and can edit the ranks of multiple APNs which the user hopes the application corresponds to, and displays the total flow of the data service already used that month by the wireless module corresponding to the APN at the same time;

in step 305: the main control module displays editing the APN list to the user;

in step 306: the main control module displays the default corresponding relation list of the built-in application of the operator and the APN to the user, and that list can be defined as editable and non-editable according to the operator requirement, and regarded as the reference when the user edits the above-mentioned information of the corresponding relation between the user-defined application and the APN;

in step 307: it enters the displaying and editing state, and the user can store the configuration;

in step 308: after the user selects storing the configuration, the main control module starts the data updating of the user-configuration of the multi-APN, and when the data service is started subsequently, the procedure can be started according to the new configuration;

in step 309: the main control module searches the APN corresponding to the triggered application from the information of the corresponding relation between the user-defined application and the APN, if the triggered application is corresponding to multiple APNs, then the APN is selected according to the rank and the data service link of the wireless module corresponding to the selected APN is started, then the user uses normally.

The realization and the design of the multimode multi-APN selection database is as follows:

(1) the key word of the application name: the index of the application name, used for sequencing and searching.

(2) the key word of the APN name: the index of the APN, used for sequencing and searching.

(3) the corresponding relation table of the built-in application and the APN: recording the information of the corresponding relation.

(4) the key word of the APN priority: the index of the APN priority, used for sequencing and searching.

(5) the APN priority list defined by the user: recording what priority there is and other information of priority.

(6) the corresponding relation table of the user-defined application and the APN: recording the information of the corresponding relation.

(7) the recording table of calculating and sequencing the total flow of the data service used by the application: recording the sequenced data.

(8) the recording table of calculating and sequencing the total flow of the data service used by the APN: recording the sequenced data.

(9) the recording table of calculating and sequencing the total flow of the data service used by the wireless module: recording the sequenced data.

(10) the corresponding relation table of the self-adaptation application and the APN: recording the information of the corresponding relation.

In the present embodiment, the policy of screening the APN in the multi-APN selection database:

the priority is configured as follows:

1, taking the corresponding relation between the built-in application of the operator and the APN as the highest priority (defined depending on the operator requirement), and searching in the table of corresponding relation between the built-in application of the operator and the APN;

2, searching in the corresponding relation table between the user-defined application and the APN;

3, searching in the APN priority list defined by the user;

4, searching in the list of corresponding relation between the self-adaptation application and the APN;

5, according to the wireless signal intensity information of the APN, searching the intensity information of the current network state of the corresponding APN.

More implementation of the priority ranks can be collected and completed constantly in the subsequent user experience.

An embodiment:

the present embodiment is entirely described by taking the customized requirement of a certain operator and the requirement of improvement in the user experience as an example hereinafter. The application according to the requirement of different data service links started by the user is corresponding to different scenarios of each wireless module, and these three kinds of scenarios are as follows respectively:

the scenario one is: the scenario of which the application customized by each operator carries the corresponding customized APN, and most of the operations of this scenario, according to the operator requirement and the particular built-in application of the operator, do not allow the user to edit and modify the APN corresponding to the customized application, and the corresponding relation with each APN is determined according to the requirement of each application operator.

The scenario two is: the scenario of which the user-customized application of the multi-APN configuration carries the corresponding customized APN. In the operation of this scenario, the user itself can flexibly edit the APN configuration corresponding to part or all of applications according to its own habit, or the sequencing of the total data service flow calculated by the terminal, the sequencing of the total data service flow of each APN, the sequencing of the total data service flow of each wireless module, and the data service expenses standard of the communication set menu bought by itself.

The scenario three is: the scenario that there is no user-customized application of the multi-APN configuration and the best APN is screened and optimized out according to the self-adaptation method. The operation of this scenario does not have the user self-defined information, so adopts the default leave-factory data, for example, for the mobile phone customized by the operator, each APN generally has a corresponding wireless module or corresponding application, and each wireless module has a corresponding expenses set menu, and according to the information, the terminal counts up and updates the sequencing of the total data service flow of each application, the sequencing of the total data service flow of each APN and the sequencing of the total data service flow of each wireless in real time at the same time. The terminal counts up and works out the best list of corresponding relation between the optimal self-adaptation application and the APN according to the flow sequencing. The list updates and adjusts the best corresponding relation in real time according to the using condition of the data service.

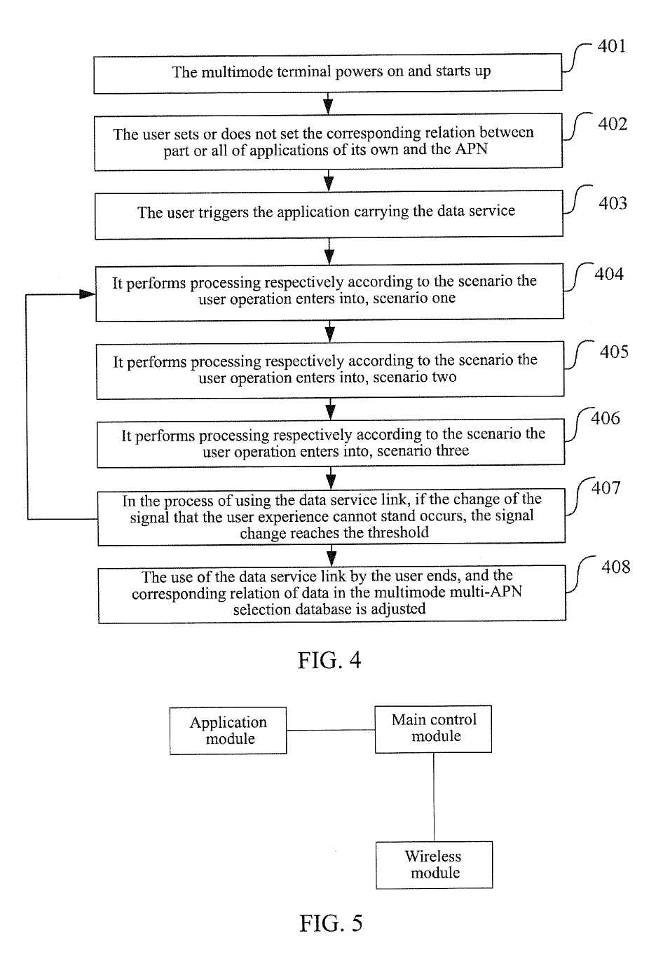

Aiming at the three scenarios above, the steps of specific embodiment are listed hereinafter, as shown in FIG. 4, including:

401: the multimode terminal powers up and starts up;

402: the user sets or does not set the corresponding relation between part or all of applications of its own and the APN;

403: the user triggers the application carrying the data service;

404: it performs processing respectively according to the scenario the user operation enters into; in the scenario one: the scenario of which the application customized by each operator carries the corresponding customized APN, in the table of the corresponding relation between the built-in application and the APN, the terminal screens out multiple APNs suitable for that application, and the main control further implements screening on the multiple APNs selected in the preceding step by utilizing the signal intensity information reported by each wireless module, screens out the APN data service link of which the signal is optimal, and starts that data service link to make it be used by the application;

405: it performs processing respectively according to the scenario the user operation enters into; in the scenario two: the scenario of which the application customized by each user carries the corresponding customized APN, in the table of the corresponding relation between the user-defined application and the APN, the terminal screens out multiple APNs suitable for that application, the main control further implements screening on the multiple APNs selected in the preceding step by utilizing the signal intensity information reported by each wireless module, screens out the APN data service link of which the signal is optimal, and starts that data service link to make it be used by the application;

406: it performs processing respectively according to the scenario the user operation enters into; in the scenario one: the scenario that there is no user-customized application and the best APN is screened and optimized according to the self-adaptation method, in the table of the corresponding relation between the self-adaption application and the APN, the terminal screens out multiple APNs suitable for that application, the main control further implements screening on the multiple APNs selected in the preceding step by utilizing the signal intensity information reported by each wireless module, screens out the APN data service link of which the signal is optimal, and starts that data service link to make it be used by the application;

407: in the process of using the data service link, if the change of the signal that the user experience cannot stand occurs, after the signal change reaches the threshold, the main control will restart the screening of steps 404˜406;

408: the use of the data service link by the user ends, and it sequences the recording table of calculating and sequencing the total flow of the data service used by the application, sequences the recording table of calculating and sequencing the total flow of the data service used by the APN, sequences the recording table of calculating and sequencing the total flow of the data service used by the wireless module, and adjusts the data corresponding relation in the multimode multi-APN selection database, for example, the user uses the dual-mode terminal of the TD and the GMS, the TV application uses 5M flow, the Browser application uses 1M flow, the TD wireless module uses the Flat-rate package charges of 100M, and the GMS uses the Flat-rate package charges of 30M. So the terminal adjusts the TV to use the APN (T-APN) corresponding to the TD wireless module; adjusts the Browser application to use the APN (G-APN) corresponding to the GMS wireless module; and when the Flat-rate package charges of 30M is used completely, it automatically adjusts the Browser application to use the APN (T-APN) corresponding to the TD wireless module.

What is shown in FIG. 5 is a framework diagram of an apparatus for selecting an access point of the present embodiment, including: an application module, a main control module and a wireless module, wherein:

the application module is configured to send a data service link request to the main control module after triggered by a user; and

the main control module is configured to select an APN for the application module from the information of a corresponding relation between the application and the APN in a multi-APN selection database according to basic information of the application module after receiving the data service link request and when the user does not start the user self-configuration of the multi-APN and the application module does not need a dedicated APN; if multiple APNs are selected from the information of the corresponding relation between the application and the APN, then an APN with the optimal signal is screened from multiple APNs that have been selected according to the detection data of the wireless signal intensity reported by the wireless module, and the wireless module corresponding to the APN with the optimal signal is started, and the data service link is established for the application.

The wireless module is configured to perform the detection on wireless signal intensity and send detection data to the main control module.

The information of the corresponding relation between the application and the APN in the multi-APN selection database contains: information of the corresponding relation between a self-adaptation application and the APN; and

the main control module is further configured to record the flow of the data service link after establishing the data service link for the application and when the application uses the data service link, and to adjust the corresponding relation between the application and the APN in the information of the corresponding relation between the self-adaptation application and the APN according to the recorded flow of the data service link.

The flow of the data service link includes: the data service flow used by the application, the data service flow used by the APN and the data service flow used by the wireless module; and

the main control module is configured to adjust the corresponding relation between the application and the APN according to the following way: sequencing total data service flow that have been used by each application, APN and wireless module; adjusting the corresponding relation of the application and the APN according to the sequencing to make the application whose data service flow that has been used is greater than a flow usage threshold correspond to the APN corresponding to the wireless module whose surplus data service flow is greater than a flow surplus threshold; making the application whose data service flow that has been used is smaller than the flow usage threshold correspond to the APN corresponding to the wireless module whose surplus data service flow is smaller than the flow surplus threshold; making the APN corresponding to the wireless module whose surplus data service flow is zero have the lowest priority.

The information of the corresponding relation between the application and the APN in the multi-APN selection database contains the information of the corresponding relation between a built-in application and the APN, the information of the corresponding relation between the user-defined application and the APN, the priority of the user-defined APN, the information of the corresponding relation between the self-adaptation application and the APN, and the wireless signal intensity information of the APN, whose priorities are from high to low; and

the main control module is further configured to select the APN for the application from the information of the corresponding relation between the application and the APN according to the above-mentioned priority.

Other functions of each module in the present apparatus please refer to the description of the content in the method.

Those skilled in the art can understand that all or part of the steps in the above-mentioned method can be fulfilled by instructing the relevant hardware components by programs, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module in the above-mentioned embodiments can be implemented in the form of hardware, or in the form of software function module. The present invention is not limited to any specific form of the combination of the hardware and software.

Obviously, the present invention can have a variety of other embodiments. Those skilled in the art can make the corresponding modifications or variations according to the present invention without departing from the spirit and essence of the present invention. And all of these modifications, equivalents or the improvements should be embodied in the scope of the appending claims of the present invention.

### INDUSTRIAL APPLICABILITY

The present invention selects different access points for the application for connecting, to realize managing the selection of multiple APNs in the multimode terminal by using the data service, and to reach and meet the objectives, such as optimally using of the user in the data service application in the Android mobile phone, improving the performance of the data service, reasonably distributing the data service use flow and reducing the data service expenses of the user, thus further improving the user experience, which can meet the customized requirement of the operator, and also can increase the data service performance of the dual-mode terminal and distribute the data service use flow of the dual-mode terminal reasonably.

1. A method for selecting an access point, comprising:
a user triggering an application required to use a data service link; and
when the user does not start user self-configuration of multi-APN and the application does not need a dedicated APN, a terminal selecting an APN for the application from information of a corresponding relation between the application and the APN in a multi-APN selection database according to basic information of the application.

2. The method according to claim 1, further comprising:
after the terminal starts up, a wireless module of that terminal performing detection on wireless signal intensity; and
if multiple APNs have been selected from the information of the corresponding relation between the application and the APN, then the terminal screening out an APN with an optimal signal from the multiple APNs which have been selected according to detection data of the wireless signal intensity of the wireless module, starting the wireless module corresponding to the APN with the optimal signal, and establishing the data service link for the application.

3. The method according to claim 1, further comprising:
before selecting the APN for the application, the terminal further judging whether the application has a particular requirement for the data service link, if yes, then recording that particular requirement, and selecting the APN for the application from the information of the corresponding relation between the application and the APN in the multi-APN selection database according to the basic information and the particular requirement of the application.

4. The method according to claim 2, further comprising:
the information of the corresponding relation between the application and the APN in the multi-APN selection database containing: information of a corresponding relation between a self-adaptation application and the APN; and
after establishing the data service link for the application, when the application uses the data service link, the terminal further recording flow of the data service link, and adjusting the corresponding relation between the application and the APN in the information of the corresponding relation between the self-adaptation application and the APN according to the flow of the data service link which has been recorded.

5. The method according to claim 4, wherein,
the flow of the data service link comprises: data service flow used by the application, data service flow used by the APN and data service flow used by the wireless module; and
the step of the terminal adjusting the corresponding relation between the application and the APN comprises: sequencing total data service flow which has been used by each application, APN and wireless module; adjusting the corresponding relation between the application and the APN according to the sequencing, causing the application whose data service flow which has been used is greater than a flow usage threshold to correspond to the APN corresponding to the wireless module whose surplus data service flow is greater than a flow surplus threshold; causing the application whose data service flow which has been used is less than the flow usage threshold to correspond to the APN corresponding to the wireless module whose surplus data service flow is less than the flow surplus threshold; causing the APN corresponding to the wireless module whose surplus data service flow is zero to have a lowest priority.

6. The method according to claim 1, further comprising:
the information of the corresponding relation between the application and the APN in the multi-APN selection database further containing: information of a corresponding relation between a user-defined application and the APN; the terminal displaying and editing the information of the corresponding relation between the user-defined application and the APN to the user when the user starts the user self-configuration of the multi-APN; and
the terminal searching for the APN corresponding to the triggered application from the information of the corresponding relation between the user-defined application and the APN, and starting the data service link of the wireless module corresponding to that APN.

7. The method according to claim 6, further comprising:
if one application corresponds to multiple APNs in the information of the corresponding relation between the user-defined application and the APN, then the terminal displaying and editing a preferential list of data service links to the user, and the list recording ranks of the multiple APNs corresponding to the application; and
when searching for the APN corresponding to the triggered application, if the triggered application corresponds to multiple APNs, then the terminal selecting an APN according to the ranks and starting the data service link of the wireless module corresponding to the APN which has been selected.

8. The method according to claim 1, further comprising:
the information of the corresponding relation between the application and the APN in the multi-APN selection database containing information of a corresponding relation between a built-in application and the APN, information of a corresponding relation between the user-defined application and the APN, a user-defined APN priority, information of a corresponding relation between a self-adaptation application and the APN and wireless signal intensity information of the APN, whose priorities are from high to low; and
the terminal selecting the APN for the application from the information of the corresponding relation between the application and the APN according to the above-mentioned priority.

9. An apparatus for selecting an access point, comprising: an application module and a main control module, wherein:
the application module is configured to send a data service link request to the main control module after being triggered by a user; and
the main control module is configured to select an APN for the application module from information of a corresponding relation between an application and the APN in a multi-APN selection database according to basic information of the application module after receiving the data service link request and when the user does not start user self-configuration of multi-APN and the application module does not need a dedicated APN.

10. The apparatus according to claim 9, further comprising a wireless module, wherein,
the wireless module is configured to perform detection on wireless signal intensity and send detection data to the main control module; and
the main control module is further configured to screen out an APN with an optimal signal from multiple APNs which have been selected according to the detection data of the wireless signal intensity reported by the wireless module if the multiple APNs are selected from the information of the corresponding relation between the application and the APN, and to start the wireless module corresponding to the APN with the optimal signal, and to establish the data service link for the application.

11. The apparatus according to claim 10, wherein, the information of the corresponding relation between the application and the APN in the multi-APN selection database contains: information of a corresponding relation between a self-adaptation application and the APN; and
the main control module is further configured to record flow of the data service link after the data service link is established for the application and when the application uses the data service link, and to adjust the corresponding relation between the application and the APN in the information of the corresponding relation between the self-adaptation application and the APN according to the flow of the data service link which has been recorded.

12. The apparatus according to claim 11, wherein, the flow of the data service link comprises: data service flow used by the application, data service flow used by the APN and data service flow used by the wireless module; and
the main control module is configured to adjust the corresponding relation between the application and the APN according to one of following ways: sequencing total data service flow which has been used by each application, APN and wireless module; adjusting the corresponding relation between the application and the APN according to the sequencing, causing the application whose data service flow which has been used is greater than a flow usage threshold to correspond to the APN corresponding to the wireless module whose surplus data service flow is greater than a flow surplus threshold; causing the application whose data service flow which has been used is less than the flow usage threshold to correspond to the APN corresponding to the wireless module whose surplus data service flow is less than the flow surplus threshold; causing the APN corresponding to the wireless module whose surplus data service flow is zero to have a lowest priority.

13. The apparatus according to claim 10, wherein, the information of the corresponding relation between the application and the APN in the multi-APN selection database contains information of a corresponding relation between a built-in application and the APN, information of a corresponding relation between a user-defined application and the APN, a user-defined APN priority, information of a corresponding relation between a self-adaptation application and the APN and wireless signal intensity information of the APN, whose priorities are from high to low; and
the main control module is further configured to select the APN for the application from the information of the corresponding relation between the application and the APN according to the above-mentioned priority.

14. The method according to claim 2, further comprising:
before selecting the APN for the application, the terminal further judging whether the application has a particular requirement for the data service link, if yes, then recording that particular requirement, and selecting the APN for the application from the information of the corresponding relation between the application and the APN in the multi-APN selection database according to the basic information and the particular requirement of the application.
